(19) United States
(12) Patent Application Publication
(10) Pub. No.: US 2004/0080544 A1
(43) Pub. Date: Apr. 29, 2004

(54) System and method for providing network access to devices using numeric input

(76) Inventor: Jeffrey Ricks Stripling, Austin, TX (US)

Correspondence Address: Jeffrey Ricks Stripling, 13208 Kincaid Court, Austin, TX, 78727, US

(21) Appl. No.: 10/282,581

(22) Filed: Oct. 29, 2002

(51) Int. Cl. G09G 5/00

(52) U.S. Cl. 345/816; 345/864

(57) ABSTRACT

A system and method are disclosed for improving the ease with which owners of numeric keypad based devices access a network. Numeric keypads have ten numeric keys and may optionally have additional keys and events. This invention improves access by using the keys already on the numeric keypad device instead of forcing the user to generate alphanumeric strings. The user enters numeric strings that a device translates into network locations using the Uniform Resource Identifier (URI) format. The URI is resolved into data that is accessed across the network and returned to the user. This invention allows users of telephones, televisions, automated teller machines and other similar devices known to those having ordinary skill in the art to more easily access the Internet and other similar networks.

### BACKGROUND OF THE INVENTION

As more and more electronic devices are connected to a network, users of many types of devices are demanding access to Internet and intranet sites. Providers of these sites advertise their location using an address commonly known as a Uniform Resource Identifier (“URI”). These identifiers are also called Uniform Resource Locators (“URL”) or Uniform Resource Names (“URN”) in technical documentation. URIs consist of alphanumeric characters and some punctuation characters as specified by the Internet Engineering Task Force Request for Comment (RFC) 2396. For example, standard URIs used to access content on the Internet are formed using the following format:

<protocol>//<domain name>/<subdirectory name>/<file name>

The domain name is read from right to left and includes a top level domain, a machine name, and a web server name according to the following format: “<web server>.<machine name>.<top level domain>”. For example, in the Internet recognizable URI “http://www.tetric.com/history/index.html”, “http:” is the protocol, “www” is the web server, “tetric” is the machine name, “com” is the top level domain, “history” is the subdirectory name, and “index.html” is the file name. Thus, due to the standard Internet conventions, a well-formed URI for a computer in a top level domain requires one or more period characters, one or more forward slash characters, and at least two characters from the set of lower case alphabetical letters [a-z].

This system was designed for traditional computers with full keyboards, but today many networkable devices have an input device that has a different set of keys than a traditional keyboard. Entering URIs on any device that does not provide the full set of characters commonly used in a URI is difficult or impossible. Devices with numeric keypads have at a minimum the keys zero through nine plus possibly the asterisk (“*”) and pound (“#”) keys. On their own, these devices lack the alpha keys and the punctuation keys needed to generate a well formed URI and cannot easily access the Internet. Devices in this set include but are not limited to television remote controls, corded and cordless telephones, cellular telephones, automated teller machines, and handheld calculators.

Previous attempts at entering text from keypads include virtual keyboards, chording keyboards, and assigning a set of alphanumeric keys to each numeric key. Some television displays use virtual keyboards, a method of entering text by displaying a set of characters onscreen and allowing the user to navigate among the keys using up, down, left and right keys and pressing a select button to enter text. Chorded keyboards convert a set of multiply pressed keys to text characters by training the user which keys pressed in combination generate which text characters. Some cellular telephones assign multiple keys to each numeric key to allow the user to enter names of contacts into telephone directories. All of these methods allow the user to press non-alphanumeric keys to generate alphanumeric text and could be used to generate URIs to access Internet content.

### SUMMARY OF THE INVENTION

The present invention, in the field of coded data conversion for keyboard or keypad based devices, allows content providers to create a constant string to enable users of devices with non-alphanumeric keyboards or keypads to access the Internet using well formed URIs. The invention provides improvements over the methods listed above by being consistent across all devices that use the invention, requiring no keys in excess of those on a numeric keypad, and allowing the user to access Internet sites with the same ease of use as dialing a telephone number or entering a television channel number.

As stated above, many devices used by consumers today offer numeric keypads but lack a full alphanumeric keypad. For the purpose of this invention, these are called numeric keypad devices. These devices may offer other keys beyond the simple 0-9 numeric keys, but they lack the full alphanumeric keyboard found on keyboards used with personal computers. More and more of these numeric keypad devices have data connections to the Internet but do not offer alphanumeric keys to enter Internet addresses. Today's numeric keypad devices use their limited set of keys to generate other characters that are in the proper set and build strings from these characters to generate commonly known URIs. This invention fundamentally changes that paradigm by creating a new set of Internet addresses using keys available on numeric keypad devices.

Using this invention, Internet content providers choose a new string to represent an alternative way of reaching their website, called a “domain number” for the purposes of this invention. A domain number consists of a string of characters commonly found on numeric keypad devices. Each domain number is associated with a specific Internet address. The content provider creates an Internet address associated with the chosen domain number and advertises the domain number to users of numeric keypad devices. When users wish to access the advertised location, they enter the domain number on their device and request access to the data.

The numeric keypad device then requests a connection to an infrastructure network and transmits the domain number to request the data. Ether the device or the infrastructure network transforms the domain number into a well-formed URI. The infrastructure network then uses the well-formed URI to request data from the content provider.

Upon receiving the request, the content provider can either provide the requested data or redirect the request. If the request is redirected, the infrastructure network or numeric keypad device requests data from the redirected location, and repeats this process until no more redirects are requested. If the content provider returns data instead of a redirect request, the infrastructure network forwards the data to the numeric keypad device. The end user then either sees the data on a screen, hears the data through a speaker, or uses the data in some other fashion. Once visited, sites may be logged in a history list or bookmark list for easy future access.

The invention offers several advantages over the current art. First, each device that uses this invention has the same method of operation. Once the user is trained in using the method of access on one device they will be capable of accessing the Internet from any other device using the invention. Second, the translation is consistent across all devices that employ the technology, meaning that Internet content providers can advertise a constant domain number that allows numeric keypad device users to access the provider's content. Third, the preferred embodiment using a transform function generates more keys than it consumes, meaning that users enter fewer digits to generate an Internet address and access these sites with fewer keystrokes from devices using this invention than they could from traditional keyboards. Forth, no additional standards or infrastructure are needed to implement the preferred embodiment of this invention; users of numeric keypad devices not originally compatible with the Internet will gain Internet access through use of this invention.

### BRIEF DESCRIPTION OF THE DRAWINGS

These and other objects, features, and advantages of the invention will be more readily apparent from the following detailed descriptions in which:

FIG. 1 is a system containing numeric keypad devices connected to a network.

FIG. 2 is a block diagram showing the three systems of the preferred embodiment.

FIG. 3 is the same diagram as FIG. 2 except no string storage is used.

FIG. 4 shows different types of numeric keypads.

FIG. 5 is a URI generator state machine showing state definitions used in a system with a numeric keypad and with storage area for the URI string.

FIG. 6 is a URI generator without string storage showing state definitions used in a system with a numeric keypad but without storage area for the URI string.

FIG. 7 is a URI generator state machine adding Send and End to FIG. 5.

FIG. 8 is a URI generator state machine adding a Timeout event to and removing Send and End from FIG. 7.

### DETAILED DESCRIPTION OF THE INVENTION

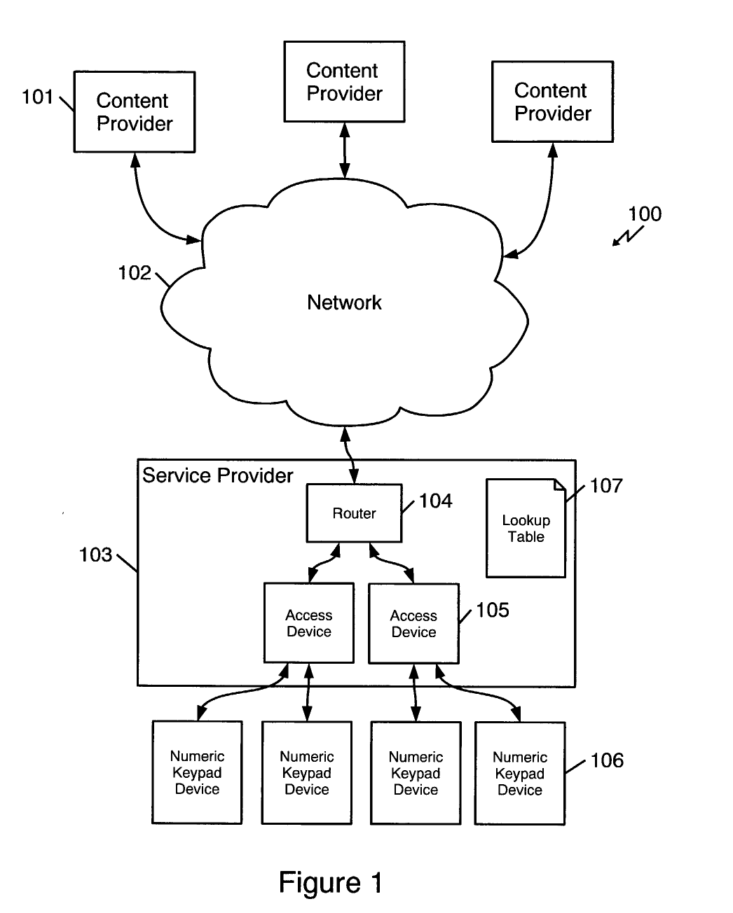

A system as shown in FIG. 1 consists of a set of numeric keypad devices 106, a service provider 103 containing access devices 105 and routers 104, a network 102, and a set of content providers 101. A numeric keypad device is a system typically designed for use by a person and contains a numeric keypad, possible other keys, a possible display for visual output, and a possible speaker for audible output among other components. Examples of numeric keypad devices are telephones and television controls. More and more numeric keypad devices are now offering a data connection to the Internet or other networks.

In the system shown in FIG. 1, a content provider 101 secures a “domain number” to go with the provider's “domain name”. This content provider advertises the new domain number along with today's familiar domain name as a method of gaining access to the content provider's site from numeric keypad devices. For example, the content provider for the domain “tetric.com” might secure the domain number 1234501 as an alternate way of connecting to “tetric.com”. The content provider creates content for numeric keypad devices and advertises the content to users by telling them the domain number.

A user of numeric keypad device 106 in FIG. 1 wishes to view the content advertised by the content provider 101. The user enters the domain number provided by the content provider and sends a request to access that content to the user's service provider 103.

The service provider 103 receives the request via an access device 105. The service provider has a lookup table 107 that contains a list of every registered domain number and the URI associated with that domain number. For example, the user may request the domain number 1234501 and the service provider would find this number in the lookup table and transform it into the URI “http://www.tetric.com/”. In one embodiment, the lookup table is specific to the service provider. In an alternate embodiment, the look-up table is global to all networks, periodically transferred to each service provider from a network authority. In an alternate embodiment, the lookup table mechanism is replaced by a transform function that generates one and only one URI for each possible domain number.

The service provider 103 then transmits the URI request to the network 102, typically using a router 104. The network routes the URI request to the proper content provider 101. The content provider either returns content associated with the requested URI, or issues a redirect order to transfer content from another URI. If a redirect order is returned, either the service provider or the numeric keypad device requests the redirected URI and this process repeats until the final URI is reached and content is returned.

This content may take any form that can be specified by a URI. Examples of such content include hypertext markup language (HTML) pages, wireless access protocol (WAP) pages, images, movies, and other such content commonly transferred across networks.

The content is transferred from the content provider 101 to the network 102 and then to the service provider 103 and finally to the numeric keypad device 106. The device may store the content, place it on a display, play it through a speaker, or use it in a manner appropriate for the device.

The end user has thus accessed content on a network by inputting a number, having that number transformed into a properly formed URI, and using the URI to address the content across a network. The user may be unaware of the URI associated with the number. To the end user, the number provided by the content provider is the actual address of the network content.

Domain numbers are created as a string of numeric digits from the set [0-9] inclusive. URIs are made of a string of characters as listed in the Internet Engineering Task Force RFC 2396, a document specifying the URI format. The domain number may be translated into a URI using a variety of methods, described in the following sections. Certain sets of numeric keypad devices, such as telephones, all share other common keys such as the star (“*”) and pound (“#”) keys, which could be included in the set of numeric digits in an alternate embodiment.

Transforming the Number into a URI Using a Lookup Table

One method of transforming the domain number into a URI uses a lookup table. In this method, content providers request domain numbers to be associated with a domain string. A table is built from all of the domain number and domain string parings, associating each domain number with its domain string. Whenever a domain number is to be converted to a domain string, the user of the table looks for the domain number in the table. If the number is found, the result is the domain string associated with the given domain number. If the number is not found, the result is not valid and the domain number cannot be resolved into a URI. An example of this type of table is shown below:

TABLE 1
Sample Domain Numbers and URIs

| Domain Number | URI |
|---|---|
| 12345 | http://www.tetric.com/ |
| 1234567 | http://www.tetric.com/tvcontent/ |
| 1234568 | http://www.tetric.com/testimage.jpg |

In the above example, the domain number 12345 would resolve into the URI “http://www.tetric.com/”, the domain number 1234567 would resolve into the URI “http://www.tetric.com/tvcontent/” and the domain number 123 would be considered not valid because it is not listed in the table.

In another embodiment using the lookup table, a single character from the numeric set is chosen to be a delimiter. Numbers in the lookup table for this case must not contain the delimiter character. Domain numbers for this case consist of a set of numeric digits without the delimiter, followed by an optional delimiter, followed by an optional set of numeric digits. When translating domain numbers into URIs, the domain number is separated into the portion before the delimiter, called the URI identifier and the portion after the delimiter, called the URI suffix. The lookup table is consulted to see if the URI identifier is listed as a domain number. If it is found, the result is the URI string from the table appended with the URI suffix.

Using the previous table as the lookup table and using zero as the delimiter, examples of domain numbers and the appended URIs are shown below:

TABLE 2
Sample Domain Numbers and Lookup Table Generated URIs

| Domain Number | Generated URI: |
|---|---|
| 12345 | http://www.tetric.com/ |
| 123450 | http://www.tetric.com/ |
| 123450123 | http://www.tetric.com/123 |
| 12345012304 | http://www.tetric.com/12304 |

In the system shown in FIG. 1, the lookup table 107 is shown as part of the service provider 103. The lookup table may also be stored elsewhere in the system with the same result, including but not limited to storage in the router 104, the access device 105, or the numeric keypad device 106. The look-up table might even be split into separate tables so that part of the domain number specifies which look-up table to use and another part of the domain number specifies a location in that lookup table. Regardless of storage location, some device in the chain between the numeric keypad device and the content provider is converting numbers to strings that represent content locations.

Transforming the Number into a URI a Transform Function

Lookup tables provide great flexibility in associating almost any number with almost any URI. But these tables must be maintained, could grow quite large, and may have to be distributed among different machines. In a different embodiment, the same system from FIG. 1 is used but instead of a lookup table, a function converts domain numbers into URIs. A function for this purpose is a set of rules used to transform a domain number into a URI such that for any given domain number exactly one and only one URI exists. The same fundamental process of converting a domain number to a URI is involved, but the device doing the conversion uses a function rather than a lookup table.

In one embodiment, the set of rules is very simple, including prefixing the number with one string and appending it with a second string. In this case, the first string might be “http://” and the second string might be the address of a current top level domain, such as “.com/”, or a new top level domain, such as “.number/”. If the “http://” and “.com/” strings were selected as prefix and postfix strings respectively, examples of domain numbers and their generated URIs would be:

TABLE 3
Sample Domain Numbers and Transform Function Generated URIs

| Domain Number: | Generated URI: |
|---|---|
| 12345 | http://12345.com/ |
| 123450 | http://123450.com/ |

In another embodiment using a function, a single character from the numeric set is chosen as a delimiter. Domain numbers for this case consist of a set of numeric digits without the delimiter, followed by a first optional delimiter, followed by a first optional set of numeric digits, followed by a second optional delimiter, followed by a second optional set of numeric digits, followed by a terminating delimiter. In this case the domain number is separated into the portion before the first delimiter, interpreted as a string and called the “MachineName”, the portion between the first and second optional delimiters, interpreted as an integer and called the “DomainCnt”, and the portion after the second delimiter, interpreted as a string and called the “Extension”. If the DomainCnt is not provided, it is optionally set to a default value. If the Extension is not provided, it is not used in constructing the URI.

The DomainCnt is used to look up a domain string using a table, an example of which is shown in Table 6 on page 12. If the DomanCnt is reserved or not valid then the provided domain number is not valid. Otherwise, the URI is constructed by concatenating the string “http://” with the MachineName, adding a dot (“.”), adding the domain string, adding a forward slash (“/”), and adding the extension if provided. Examples of this type of function are shown below:

TABLE 4
Sample Domain Numbers and Transform Function Generated URIs

| Domain | Machine- | | | |
|---|---|---|---|---|
| Number | Name | DomainStr | Extension | URI |
| 123450 | 12345 | com | none | http://12345.com/ |
| 12345010 | 12345 | com | none | http://12345.com/ |
| 12345020340 | 12345 | net | 34 | http://12345.net/34 |
| 1230110110 | 123 | mil | 11 | http://123.mil/11 |

In another embodiment using a function, the same process described by the previous embodiment is used except the first optional delimiter and first optional set of numeric digits are not optional but instead must be provided.

In another embodiment, the function modifies MachineName by adding additional characters before, after, or in between the MachineName digits. Examples of this type of modification might be prefixing MachineName with the string “abc” (e.g., “abc12345” from “12345”), postfixing MachineName with the string “xyz” (e.g., “12345xyz” from “12345”), or inserting the character “a” between each MachineName digit (e.g., “1a2a3a4a5” from “12345”). The function might also switch the order of the MachineName digits (e.g., “54321” from “12345”) or substitute one or more characters for each MachineName digit (e.g., “abcde” from “12345”). Other modifications of the MachineName could be used as desired. The examples from the previous table are shown below, prefixed with the string “ndl”:

TABLE 5
URIs Generated by Functions using Machine Name Prefixes

| Domain | | Modified | |
|---|---|---|---|
| Number | MachineName | MachineName | URI |
| 123450 | 12345 | nd112345 | http://nd112345.com/ |
| 12345010 | 12345 | nd112345 | http://nd112345.com/ |
| 12345020340 | 12345 | nd112345 | http://nd112345.net/34 |
| 1230110110 | 123 | nd1123 | http://nd1123.mil/11 |

In this system shown in FIG. 1, the transform function may be placed in many different parts of the system with the same result, including but not limited to storage in the router 104, the access device 105, or the numeric keypad device 106. Regardless of which device incorporates the transform function, a device in the chain between the numeric keypad device and the content provider is converting numbers to strings that represent content locations.

Handling Different Types of Numeric Keypad Devices

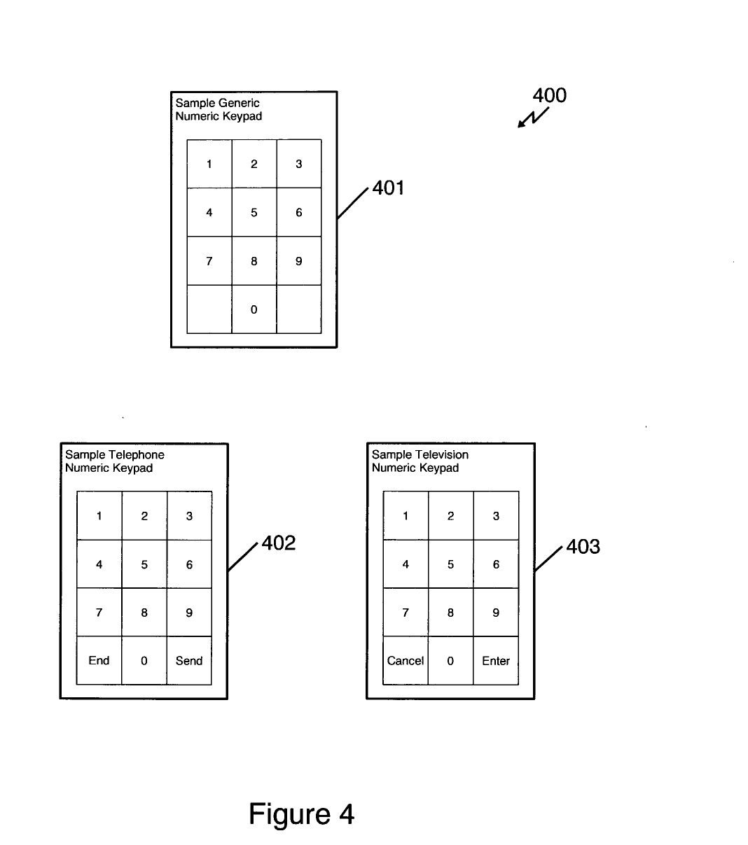

Samples of different types of keypads commonly used on numeric keypads are shown in FIG. 4. These include a generic numeric keypad 401, containing just the numeric keys [0-9], a sample telephone keypad 402 containing the numeric keys plus additional Send and End keys, and a sample television control 403, containing the numeric keys plus additional Enter and Cancel keys. The embodiments described above assume no keys beyond those on the generic numeric keypad, however this invention is easily extended to include these other types of keypads.

Keys such as “Send” and “Enter”, collectively called Send keys, convey the user's desire to terminate entry of numeric keys and evaluate any previous numeric keys at the time the “Send” or “Enter” key is pressed. Keys such as “End” or “Cancel”, collectively called End keys, convey the user's desire to abort entry of numeric keys and discard any partial results.

A user Timeout, defined as an event that occurs a fixed time period after the last key has been pressed, may substitute for the Send key or the End key or may replace both keys.

The Send key and user Timeout may also serve as the final delimiter for embodiments employing a final delimiter, in these cases the Send key or user Timeout event may serve as the final delimiter and terminate data entry.

Other additional keys may be added to the keypad and further assist the user. The examples above improve the invention on the described keypads and one familiar with the art can envision alternate keyboards used to enter numeric strings.

Different Methods of Storing the Generated Address

More than one method exists for storing the partially generated string. In one method, the device implementing the invention contains a string storage area and the device builds a URI as it receives keypress events. The entire string is transmitted at the time the device determines that the string is complete. The next device receives the entire URI at one time.

In an alternate method, the device implementing the invention does not contain a string storage area but instead transmits fragments of the URI to the next downstream device. The device is capable of sending a Done signal to indicate that a complete URI has been transmitted or a Cancel signal to indicate that the user has abandoned the URI. The receiver assembles the fragments into the final URI by taking the first fragment received and appending additional fragments in order of receipt. If the receiver receives a Done signal, it knows that the URI is complete. If the receiver receives a Cancel signal, it knows that the user wishes to abandon the URI.

Example Embodiments of the Transform Function Method

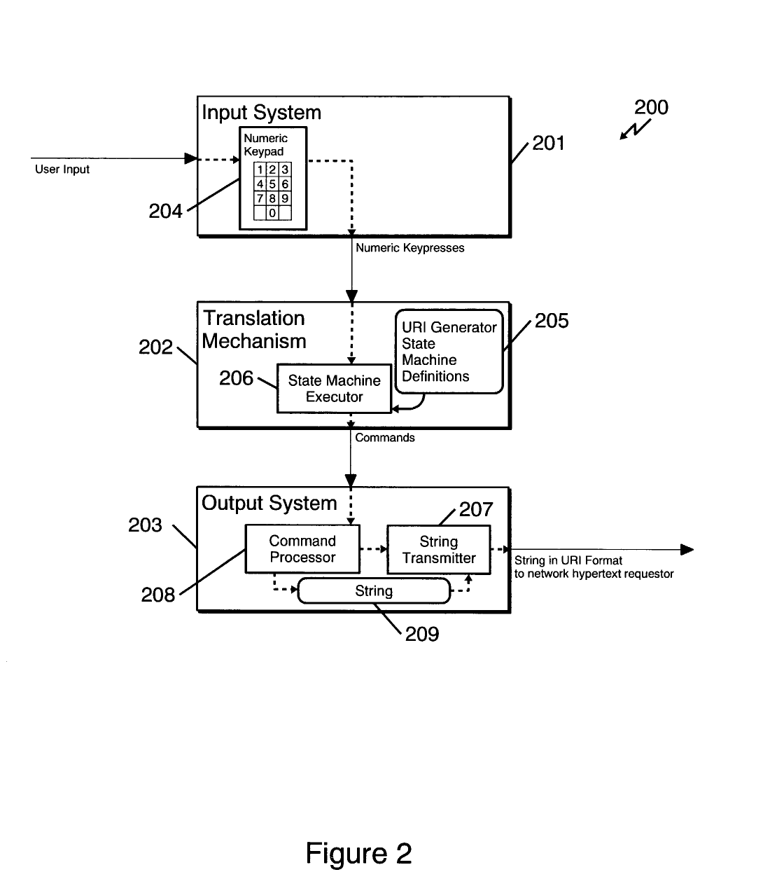

As an example embodiment of the transform function method, a system is constructed in FIG. 2 consisting of an input system 201 containing keys from a numeric keypad device, a translation mechanism 202 to convert keypresses from the input domain to a string in an output domain, and an output system 203 that submits strings using characters used to construct URIs to an receiving device.

The input system has a set of numeric keys and possibly other keys accessible by the user. As the user presses keys on the input system, a Keypad 204 generates keypresses as shown in FIG. 2 and sends them to the translation mechanism.

The translation mechanism has a set of rules 205, called the State Machine Definitions, for converting the keypresses to a URI string. This conversion mechanism may be expressed as a finite state machine and is commonly implemented in a coding language such the C programming language. The conversion mechanism is shown as a State Machine Executor 206.

The State Machine Definitions define a set of states and their connections. Each state has a set of edges connecting it to other states in the machine. Each state must have an edge to traverse for each possible keypress from the input domain. One of the states is the designated start state and the system goes to this state upon startup and reset.

Each edge has two portions, the input value and an ordered set of output actions. The input value consists of one or more keys or events. The ordered set of output actions describes what the machine must do if this edge is traversed. Actions include but are not limited to adding characters to an output string, resetting the output string to the null string, transmitting the string, transmitting string fragments, transmitting control signals, resetting variables, adding and subtracting from variables, and multiplying variables by a value. Each edge connects two states, starting at one state and ending at the other state.

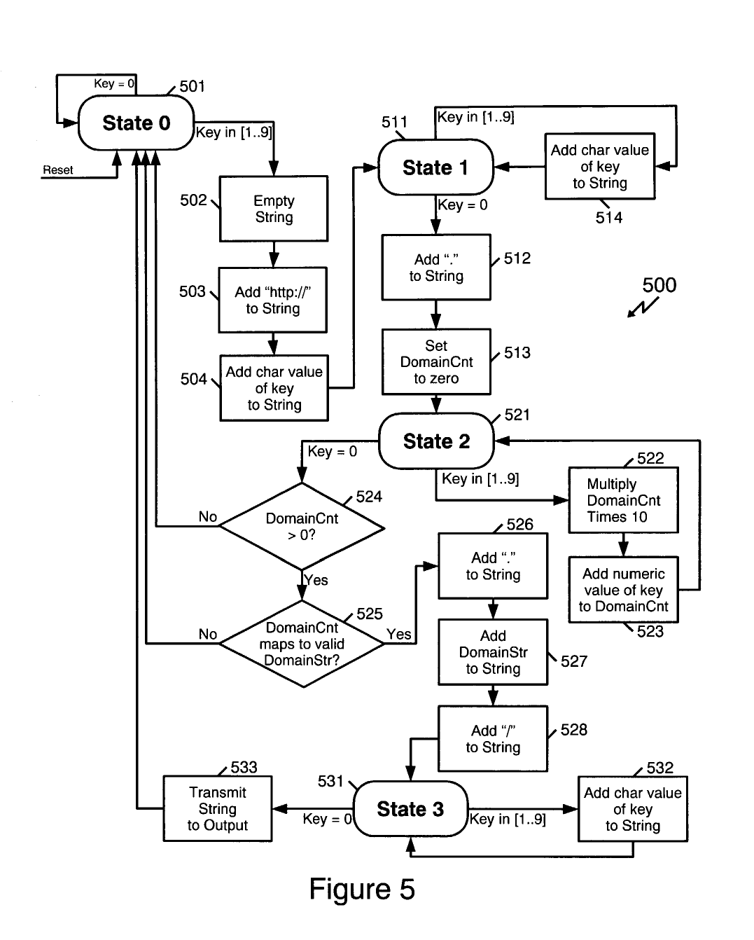

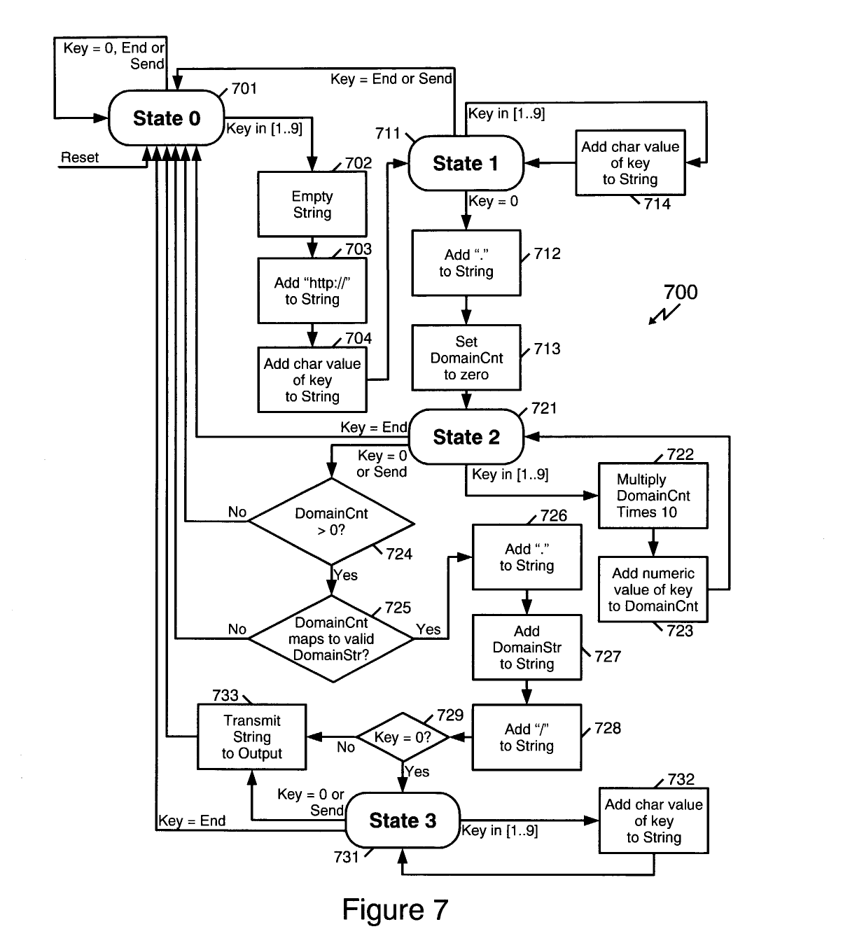

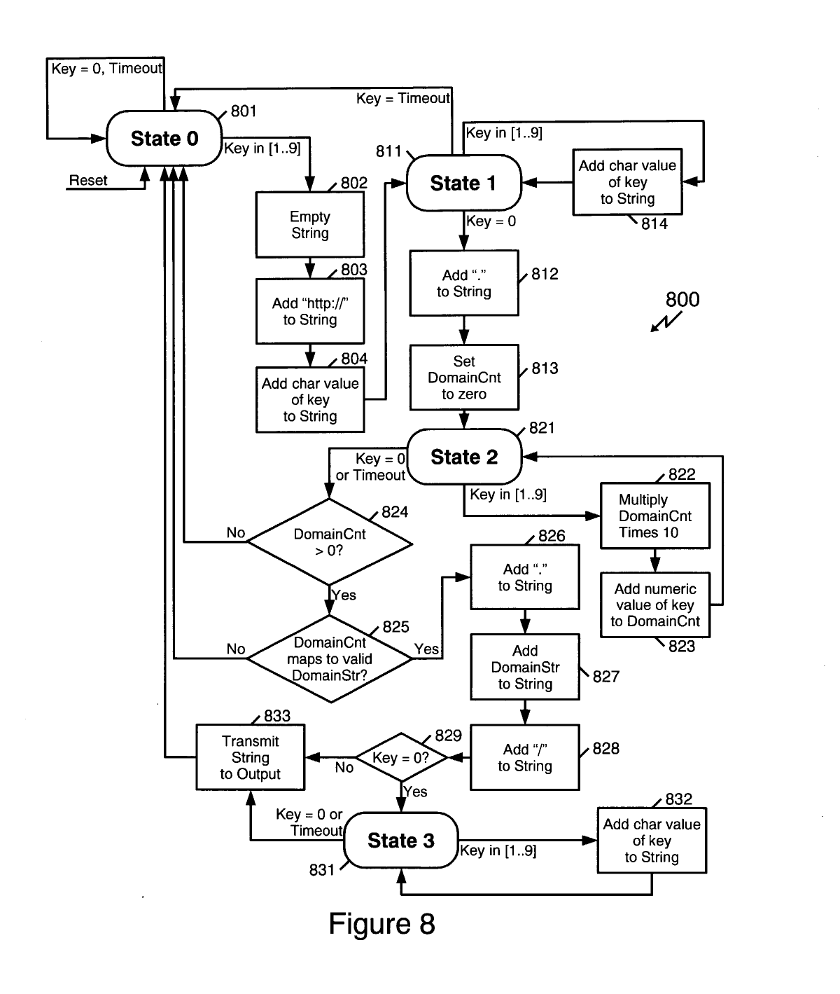

In one embodiment of the invention, shown in FIG. 2, the output system contains memory to hold a string 209. As the translation mechanism traverses the state machine, the mechanism sends commands to the output system command processor 208 to build the text string. Commands can include adding characters to the end of the string, resetting the string to a length of zero, or a command to transmit the string to the receiving device. If the add command is received, the command processor 208 adds the indicated characters to the end of the string and increases the length of the string by the number of added characters. If the reset command is received, the command processor 208 sets the length of the string to zero and erases any current characters from the string. If the transmit command is received, the command processor 208 instructs a string transmitter 207 to send the contents of the string to a receiving device in the order in which the characters were added, then resets the string. If the memory for the string is finite and the add command is received and adding the characters would exceed the memory available to hold the string, the command processor resets the string and tells the state machine executor 206 to reset itself to its start state. FIG. 5 shows an example of a state machine using string memory as shown in FIG. 2. FIG. 7 shows modifications to the state machine to use Send and End keys and FIG. 8 shows modifications to the state machine to use user Timeout.

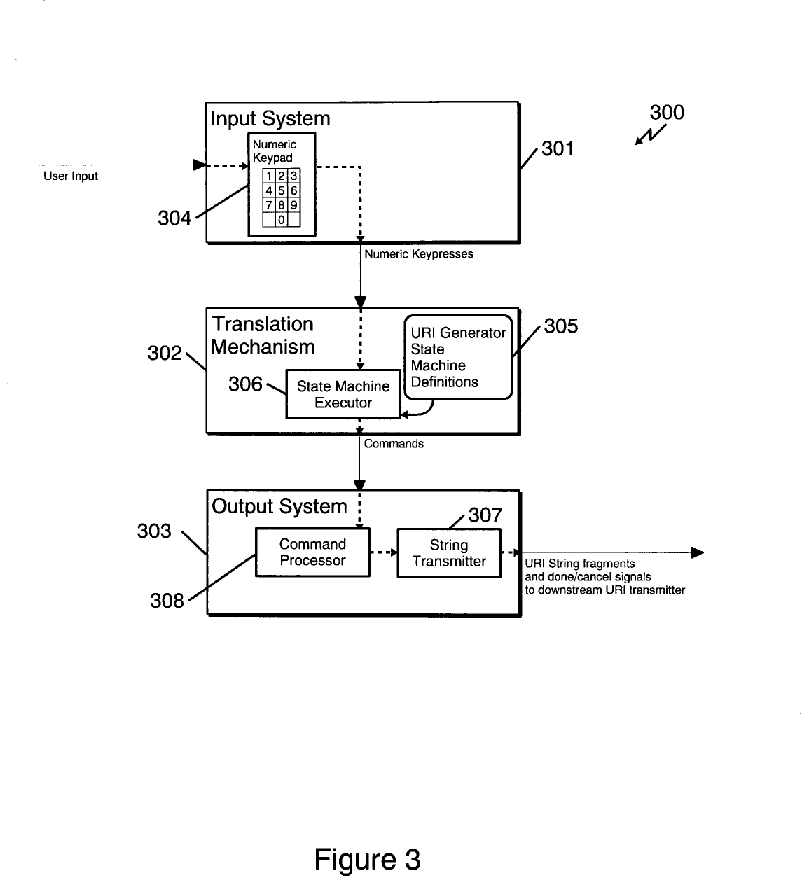

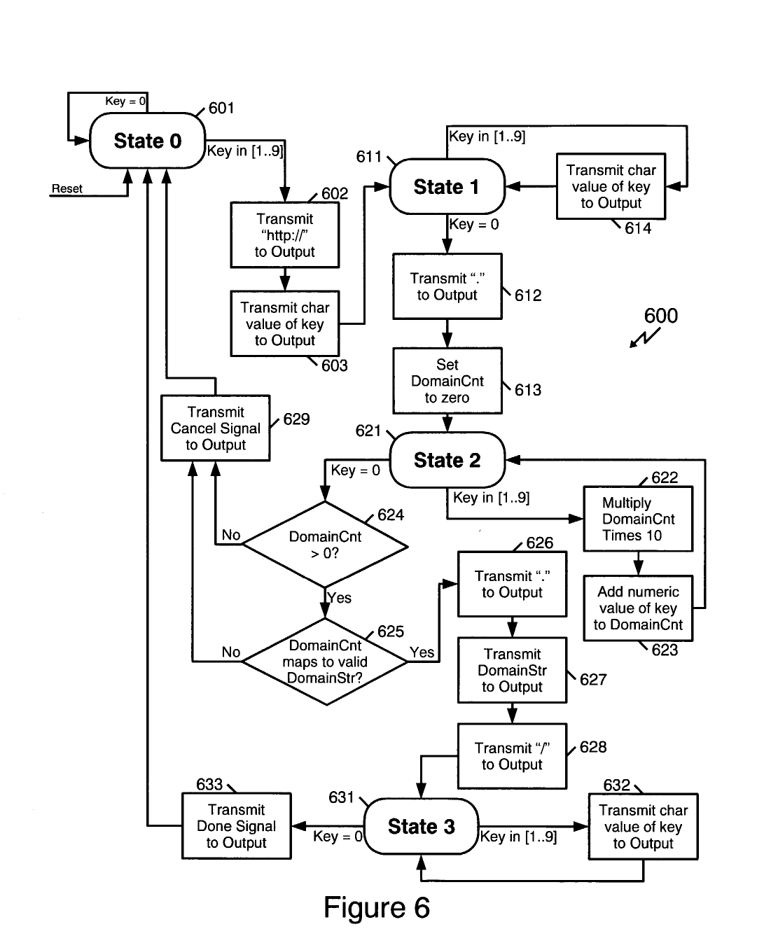

In another form of the translation mechanism and output system, shown in FIG. 3, the translation mechanism 302 sends commands to transmit string fragments and additional control signals to indicate the status of the string to the output system 303. In this case, no string memory is required in the output system 303. FIG. 6 shows an example of a state machine designed to be used with FIG. 3.

Each state machine drawing uses an integer DomainCnt variable and is required to determine if the value of this variable is Valid or Not Valid and, if Valid, what value for a string variable called DomainStr is used for each value of DomainCnt. For a DomainCnt value to be Valid it must not have any zero digits and it must have a DomainCnt string assigned to it. Otherwise DomainCnt is Not Valid.

Sample values of DomainCnt and the DomainCnt string (called DomainStr) for DomainCnt values from 1 to 13 are shown in Table 6 on page 12. In this example all other values are either reserved for future use and therefore not valid or not valid because they contain a zero delimiter character:

TABLE 6
Sample DomainCnt Validity and DomainStr Translation

| DomainCnt | Validity | DomainStr |
|---|---|---|
| 1 | Valid | “com” |
| 2 | Valid | “net” |
| 3 | Valid | “org” |
| 4 | Valid | “info” |
| 5 | Valid | “biz” |
| 6 | Valid | “name” |
| 7 | Reserved-not valid | n/a |
| 8 | Reserved-not valid | n/a |
| 9 | Reserved-not valid | n/a |
| 10 | Not Valid | n/a |
| 11 | Valid | “mil” |
| 12 | Valid | “edu” |
| 13 | Valid | “gov” |

Each state machine drawing also converts keys to a “char value” and a “numeric value”. The conversion table for these keys is shown below:

TABLE 7
Numeric Key Translation to Char Value and Numeric Value

| Numeric Key | Char Value | Numeric Value |
|---|---|---|
| 0 | “0” | 0 |
| 1 | “1” | 1 |
| 2 | “2” | 2 |
| 3 | “3” | 3 |
| 4 | “4” | 4 |
| 5 | “5” | 5 |
| 6 | “6” | 6 |
| 7 | “7” | 7 |
| 8 | “8” | 8 |
| 9 | “9” | 9 |

All of the state machines show a URI Prefix as the string “http://”. This prefix is shown as an example and other implementations might choose a different Prefix to generate a different set of URIs.

Detailed Description of FIG. 5, a State Machine with Numeric Keys and String Storage

The state machine shown in FIG. 5 is intended for devices with a numeric keypad and storage for a URI string, called the String. This machine contains four states 501, 511, 521 and 531, which are numbered State 0, State 1, State 2 and State 3, respectively. The machine starts in and resets to State 0.

From State 0 key is pressed the machine remains in State 0. If any key from 1 through 9 is pressed, the machine issues commands to empty the String in block 502, to add the prefix string “http://” to the String in block 503, and then to add the “char value” of the key to the String in block 504. The state machine then advances to State 1.

From State 1, if any key from 1 through 9 is pressed, the machine issues commands to add the “char value” of the key to the String in block 514 and then returns to State 1. From State 1, if the 0 key is pressed, the machine issues commands to add a period “.” character to the String in block 512, to set the DomainCnt variable to zero in block 513. The state machine then advances to State 2.

From State 2, if any key from 1 through 9 is pressed, the machine issues commands to multiply the DomainCnt variable times ten in block 522, to add the “numeric value” of the key to the variable DomainCnt in block 523. The state machine then returns to State 2. From State 2, if the 0 key is pressed, the machine checks the value of DomainCnt against the valid values for DomainCnt in decision block 524. If the value for DomainCnt is greater than zero and the value for DomainCnt maps to a valid DomainStr value as determined in decision block 525, the machine issues commands to add a period character “.” to the String in block 526, to add the value of DomainStr associated with the value of DomainCnt to the String in block 527, and to add a forward slash “/” character to the String in block 528. The state machine then advances to State 3. Otherwise the machine advances to State 0.

From State 3, if any key from 1 through 9 is pressed, the machine issues commands to add the “char value” of the key to the String in block 532 and then returns to State 3. If the 0 key is pressed from State 3, the machine issues a command to transmit the String to the output in block 533 and then advances to State 0.

Detailed Description of FIG. 6, Without String Storage

The state machine shown in FIG. 6 is intended for devices with a numeric keypad but without storage for a URI string. This machine contains four states 601, 611, 621 and 631, which are numbered State 0, State 1, State 2 and State 3, respectively. The machine starts in and resets to State 0.

From State 0, if the 0 key is pressed the machine remains in State 0. If any key from 1 through 9 is pressed, the machine issues commands to transmit the prefix string “http://” to the output in block 602, and then transmit the “char value” of the key to the output in block 603. The machine then advances to State 1.

From State 1, if any key from 1 through 9 is pressed, the machine issues commands to transmit the “char value” of the key to the output in block 614 and then returns to State 1. From State 1, if the 0 key is pressed, the machine issues commands to transmit a period “.” character to the output in block 612, and to set the DomainCnt variable to zero in block 613. The machine then advances to State 2.

From State 2, if any key from 1 through 9 is pressed, the machine issues commands to multiply the DomainCnt variable times ten in block 622, to add the “numeric value” of the key to the variable DomainCnt in block 623. The state machine then returns to State 2. From State 2, if the 0 key is pressed, the machine checks the value of DomainCnt against the valid values for DomainCnt in decision block 624. If the value for DomainCnt is greater than zero and the value for DomainCnt maps to a valid DomainStr value as determined in decision block 625, the machine issues commands to transmit a period character “.” to the output in block 626, to transmit the value of DomainStr associated with the value of DomainCnt to the output in block 627, and to transmit a forward slash “/” character to the output in block 628. The state machine then advances to State 3. Otherwise the machine transmits a Cancel signal to the output in block 629 and then advances to State 0.

From State 3, if any key from 1 through 9 is pressed, the machine issues commands to transmit the “char value” of the key to the output in block 632 and then returns to State 3. From State 3, if the 0 key is pressed, the machine issues a command to transmit a Done signal to the output in block 633 and then advances to State 0.

Detailed Description of FIG. 7, Adding Send and End Keys

The state machine shown in FIG. 7 is intended for devices with a numeric keypad plus additional Send and End keys and storage for a URI string, called the String. This machine contains four states 701, 711, 721 and 731, which are numbered State 0, State 1, State 2 and State 3, respectively. The machine starts in and resets to State 0.

From State 0, if the 0 key, End key, or Send key is pressed the machine remains in State 0. From State 0, if any key from 1 through 9 is pressed, the machine issues commands to empty the String in block 702, to add the prefix string “http://” to the String in block 703, and then to add the “char value” of the key to the String in block 704. The state machine then advances to State 1.

From State 1, if any key from 1 through 9 is pressed, the machine issues commands to add the “char value” of the key to the String in block 714 and then returns to State 1. From State 1, if the End or Send key is pressed, the machine advances to State 0. From State 1, if the 0 key is pressed, the machine issues commands to add a period “.” character to the String in block 712, and to set the DomainCnt variable to zero in block 713. The state machine then advances to State 2.

From State 2, if any key from 1 through 9 is pressed, the machine issues commands to multiply the DomainCnt variable times ten in block 722, to add the “numeric value” of the key to the variable DomainCnt in block 723. The machine then returns to State 2. From State 2, the machine returns to State 0 if the End key is pressed. From State 2, if the 0 key or Send key is pressed, the machine checks the value of DomainCnt against the valid values for DomainCnt in decision block 724. If the value for DomainCnt is not greater than zero or the value for DomainCnt does not map to a valid DomainStr value as determined in decision block 725, then the machine advances to State 0. Otherwise, the machine issues commands to add a period character “.” to the String in block 726, to add the value of DomainStr associated with the value of DomainCnt to the String in block 727, and to add a forward slash “/” character to the String in block 728. The machine then advances to State 3 if the 0 key was pressed as determined in decision block 729. Otherwise, the machine issues a command to transmit the String to the output in block 733 and then advances to State 0.

From State 3, if any key from 1 through 9 is pressed, the machine issues commands to add the “char value” of the key to the String in block 732 and returns to State 3. From State 3, if the 0 key or Send key is pressed, the machine issues a command to transmit the String to the output in block 733 and advances to State 0. From State 3, if the End key is pressed, the machine returns to State 0.

Detailed Description of FIG. 8, Adding User Timeout

The state machine shown in FIG. 8 is intended for devices with a numeric keypad plus a Timeout event and storage for a URI string, called the String. This machine contains four states 801, 811, 821 and 821, which are numbered State 0, State 1, State 2 and State 3, respectively. The machine starts in and resets to State 0.

From State 0, if the 0 key is pressed or the Timeout event occurs, the machine remains in State 0. From State 0, if any key from 1 through 9 is pressed, the machine issues commands to empty the String in block 802, to add the prefix string “http://” to the String in block 803, and then to add the “char value” of the key to the String in block 804. The state machine then advances to State 1.

From State 1, if any key from 1 through 9 is pressed, the machine issues commands to add the “char value” of the key to the String in block 814 and returns to State 1. From State 1, if the 0 key is pressed, the machine issues commands to add a period “.” character to the String in block 812, to set the DomainCnt variable to zero in block 813, and then advances to State 2. From State 1, the machine returns to State 0 if the Timeout event occurs.

From State 2, if any key from 1 through 9 is pressed, the machine issues commands to multiply the DomainCnt variable times ten in block 822, to add the “numeric value” of the key to the variable DomainCnt in block 823, and then returns to State 2. From State 2, if the 0 key is pressed or the Timeout event occurs, the machine checks the value of DomainCnt against the valid values for DomainCnt in decision block 824. If the value for DomainCnt is not greater than zero or the value for DomainCnt does not map to a valid DomainStr value as determine in decision block 825, then the machine advances to State 0. Otherwise, the machine issues commands to add a period character “.” to the String in block 826, to add the value of DomainStr associated with the value of DomainCnt to the String in block 827, and to add a forward slash “/” character to the String in block 828. The machine then advances to State 3 if the 0 key was pressed as determined by decision block 829. Otherwise, the machine issues a command to transmit the String to the output in block 833 and advances to State 0.

From State 3, if any key from 1 through 9 is pressed, the machine issues commands to add the “char value” of the key to the String in block 832 and then returns to State 3. From State 3, if the 0 key is pressed or the Timeout event occurs, the machine issues a command to transmit the String to the output in block 833 and then advances to State 0.

While the invention has been described with reference to various embodiments, it will be understood that these embodiments are illustrative and that the scope of the invention is not limited to them. Many variations, modifications, additions, and improvements of the embodiments described are possible. For example, those having ordinary skill in the art will readily implement the steps necessary to provide the structures and methods disclosed herein, and will understand that the process parameters, materials, and dimensions are given by way of example only and can be varied to achieve the desired structure as well as modifications which are within the scope of the invention. Variations and modifications or the embodiments disclosed herein may be made based on the description set forth herein, without departing from the scope and spirit of the invention as set forth in the following claims.

What is claimed is:

1. A method for allowing a communication device to identify Internet content using numeric inputs, comprising:
receiving from an input device a character string comprising a first set of one or more numeric characters identifying at least a machine name portion of a URI, the URI corresponding to Internet accessible content and comprising a machine name portion and a domain string portion; and
completing the URI by adding a string of characters identifying the domain string portion to the first set of numeric characters.

2. The method of claim 1, wherein the URI further comprises a communication protocol portion and wherein the completing step further comprises automatically adding a string of characters identifying the communication protocol portion.

3. The method of claim 1, wherein the character string further comprises at least one character representing a first delimiter that follows the first set of numeric characters.

4. The method of claim 3, wherein the completing step comprises automatically adding to a default domain string of “.com” if the character string ends with the delimiter character.

5. The method of claim 3, wherein the character string further comprises a second set of one or more numeric characters that follows the delimiter character and that identifies the domain string of the URI.

6. The method of claim 5, wherein the character string further comprises at least one character representing a second delimiter that follows the second set of numeric characters.

7. The method of claim 6, wherein the first and second delimiters are identical, and each of the first and second delimiters is a single number and the number is “0.”

8. The method of claim 6, wherein the URI further comprises an extension portion and wherein the character string further comprises a third set of one or more numeric characters that follows the second delimiter and that identifies the extension portion of the URI.

9. The method of claim 8, wherein the character string further comprises at least one character representing a third delimiter that follows the third set of numeric characters.

10. The method of claim 1, further comprising receiving a transmit input from the input device indicating that the user has finished input associated with the character string and transmitting the completed URI to a service provider.

11. The method of claim 1, further comprising transmitting the character string to a service provider.

12. The method of claim 11, wherein the completing step is done by the service provider.

13. The method of claim 12, further comprising utilizing a look-up table at the service provider to convert the character string to an Internet recognized URI.

14. The method of claim 1, wherein the input device for the communication device comprises a numeric keypad having only non-alphabetic characters.

15. The method of claim 1, wherein the communication device comprises a cell phone.

16. The method of claim 1, further comprising storing the character string within the communication device.

17. The method of claim 1, further comprising transmitting each character of the character string to a service provider as each character is input through the input device.

18. The method of claim 1, wherein the URI comprises an Internet recognized URI in which the machine name portion has only non-alphabetic characters.

19. The method of claim 1, further comprising utilizing a predetermine timeout period to indicate that the user has finished input associated with the character string and transmitting the completed URI to a service provider.

20. The method of claim 1, wherein the communication device comprises a television control.

21. The method of claim 1, further compromising automatically adding additional characters to the machine name portion of the URI, the additional characters being inserted before the numeric characters, after the numeric characters, in between the numeric characters or any combination thereof.

22. The method of claim 1, further comprising replacing each numeric character in the machine name portion with a string of one or more substitute characters.

23. The method of claim 1, further compromising automatically modifying the order of the digits in the machine name portion.

24. A communication device having a translation mechanism for identifying Internet content using numeric inputs, comprising:
an input device; and
a translation mechanism coupled to the input device to receive a character string comprising a first set of one or more numeric characters identifying at least a machine name portion of a URI, the URI corresponding to Internet accessible content and comprising a machine name portion and a domain string portion;
wherein the URI is completed by adding a string of characters identifying the domain string portion to the first set of numeric characters.

25. The communication device of claim 24, wherein the URI further comprises a communication protocol portion and wherein the translation mechanism is configured to automatically add a string of characters identifying the communication protocol portion.

26. The communication device of claim 24, wherein the translation mechanism is configured to complete the URI by adding a string of characters identifying the domain string portion.

27. The communication device of claim 24, wherein the character string includes a second set of one or more numeric characters that identify the domain string of the URI.

28. The communication device of claim 27, wherein the URI further comprises an extension portion and wherein the character string further comprises a third set of one or more numeric characters that identify the extension portion of the URI.

29. The communication device of claim 24, wherein the translation mechanism is configured to transmit the completed URI to a service provider upon receiving a transmit input from the input device.

30. The communication device of claim 24, wherein the character string is transmitted to a service provider and the service provider to converts the character string to an Internet recognized URI.

31. The communication device of claim 24, wherein the input device comprises a numeric keypad having only non-alphabetic characters.

32. The communication device of claim 24, wherein the communication device comprises a cell phone.

33. The communication device of claim 24, wherein the communication device comprises a television control.

34. The communication device of claim 24, wherein the URI comprises an Internet recognized URI in which the machine name portion has only non-alphabetic characters.

35. The communication device of claim 24, wherein additional characters are automatically added to the machine name portion, the additional characters being inserted before the numeric characters, after the numeric characters, in between the numeric characters or any combination thereof.

36. A method for identifying Internet content using numeric inputs, comprising:
receiving a character string comprising a first set of one or more numeric characters identifying at least a machine name portion of a URI, the URI corresponding to Internet accessible content and comprising a machine name portion and a domain string portion; and
completing the URI by adding a string of characters identifying the domain string portion to the first set of numeric characters.

37. The method of claim 36, wherein the URI further comprises a communication protocol portion and wherein the completing step further comprises automatically adding a string of characters identifying the communication protocol portion.

38. The method of claim 36, wherein the character string further comprises a second set of one or more numeric characters that identifies the domain string of the URI.

39. The method of claim 38, wherein the URI further comprises an extension portion and wherein the character string further comprises a third set of one or more numeric characters that identifies the extension portion of the URI.

40. The method of claim 36, wherein the character string comprises user input from a communication device, the communication device comprising an input device having a numeric keypad.

41. The method of claim 40, wherein the communication device comprises a cell phone.

42. The method of claim 40, wherein the communication device comprises a television control.

43. The method of claim 36, further compromising automatically adding additional characters to the machine name portion of the URI, the additional characters being inserted before the numeric characters, after the numeric characters, in between the numeric characters or any combination thereof.

44. The method of claim 36, further comprising replacing each numeric character in the machine name portion with a string of one or more substitute characters.

45. The method of claim 36, further compromising automatically modifying the order of the digits in the machine name portion.
